(19) United States
(12) Patent Application Publication
(10) Pub. No.: US 2024/0330971 A1
(43) Pub. Date: Oct. 3, 2024

(54) METHODS, SYSTEMS, APPARATUSES, AND DEVICES FOR PROVISIONING EXPERIENCES FOR ENHANCING ENGAGEMENTS

(71) Applicant: Manuela Seve, Los Angeles, CA (US)

(72) Inventor: Manuela Seve, Los Angeles, CA (US)

(21) Appl. No.: 18/741,834

(22) Filed: Jun. 13, 2024

(51) Int. Cl. G06Q 30/0207

(52) U.S. Cl. CPC G06Q 30/0224

(57) ABSTRACT

A method of provisioning experiences for enhancing engagements. The method includes receiving a first information from a first user device. Further, the method includes analyzing the first information. Further, the method includes generating a user interface of a platform for the provisioning of an experience based on the analyzing of the first information. Further, the method includes transmitting the user interface of the platform to a second user device. Further, the method includes obtaining a second information associated with an engagement of a second user through the user interface of the platform from the second user device. Further, the method includes analyzing the second information. Further, the method includes generating a reward for the second user based on the analyzing of the second information. Further, the method includes transmitting the reward through the user interface to the second user device. Further, the method includes storing the second information.

### FIELD OF THE INVENTION

Generally, the present disclosure relates to the field of data processing. More specifically, the present disclosure relates to methods, systems, apparatuses, and devices for provisioning experiences for enhancing engagements.

### BACKGROUND OF THE INVENTION

In a world full of connectivity, it's almost ironic that brands are facing so many issues in connecting with their clients. Traditional loyalty programs face many challenges and limitations in engaging clients and brands don't exactly know how to get to their customers and extract real data. The traditional loyalty programs fail to deliver tangible value and meaningful experiences while also failing to capture customers who engage in an ever-increasing digital world. Traditional loyalty solutions can be costly and lack integration, making it difficult to manage and track customer loyalty effectively. Also, the traditional loyalty solutions focus on rewarding points for general purchases in-stores and online, but don't track and reward customer interactions with the brand. This consequently causes them to miss out on a number of potential customers who would purchase the product or service down the line. Consumers are looking to gain value from loyalty programs and redeem points, but actual loyalty ecosystems fail to provide valuable experiences and rewards. Current loyalty solutions are inaccessible, unintuitive, and difficult to integrate with customers' daily lives and digital habits. This leads to a high level of customer inactivity (lack of engagement), low redemption rates, and consequently, disengagement with the brand.

The brands use third-party data to understand the behavior of their client. Over reliance on third-party data poses a significant challenge to building a genuine connection between brands and customers. Many companies have not prioritized collecting and analyzing first-party consumer data, so they rely on third-party data like social media analytics to understand their customer behavior. This results in shallow, disconnected insights and prevents companies from crafting specifically targeted and personalized loyalty experiences for their consumers.

Companies or brands fail to connect with their clients due to costly marketing investments, lack of access to opportunities, and lack of results. Using social media as a primary loyalty strategy can be expensive and may not always yield the desired results. On the other hand, Tier 1 sponsorship slots are only available to Fortune 500 companies due to high price points and high competition for limited slots, not allowing smaller companies to access this market. When they do have the chance to participate, there is no data available that connects market dollars spent on in-person activations with real return on Return on investment (ROI).

Therefore, there is a need for improved methods, systems, apparatuses, and devices for provisioning experiences for enhancing engagements that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of provisioning experiences for enhancing engagements, in accordance with some embodiments. Accordingly, the method may include a step of receiving, using a communication device, at least one first information from at least one first user device associated with at least one first user. Further, the method may include a step of analyzing, using a processing device, the at least one first information. Further, the method may include a step of generating, using the processing device, at least one user interface of at least one platform for the provisioning of at least one experience based on the analyzing of the at least one first information. Further, the method may include a step of transmitting, using the communication device, the at least one user interface of the at least one platform to at least one second user device associated with at least one second user. Further, the method may include a step of obtaining, using the processing device, at least one second information associated with an engagement of the at least one second user through the at least one user interface of the at least one platform from the at least one second user device. Further, the method may include a step of analyzing, using the processing device, the at least one second information. Further, the method may include a step of generating, using the processing device, at least one reward for the at least one second user based on the analyzing of the at least one second information. Further, the method may include a step of transmitting, using the communication device, the at least one reward through the at least one user interface to the at least one second user device. Further, the method may include a step of storing, using a storage device, the at least one second information.

Further disclosed herein is a system for provisioning experiences for enhancing engagements, in accordance with some embodiments. Accordingly, the system may include a communication device, a processing device, and a storage device. Further, the communication device may be configured for receiving at least one first information from at least one first user device associated with at least one first user. Further, the communication device may be configured for transmitting at least one user interface of at least one platform to at least one second user device associated with at least one second user. Further, the communication device may be configured for transmitting at least one reward through the at least one user interface to the at least one second user device. Further, the processing device may be communicatively coupled with the communication device. Further, the processing device may be configured for analyzing the at least one first information. Further, the processing device may be configured for generating the at least one user interface of the at least one platform for the provisioning of at least one experience based on the analyzing of the at least one first information. Further, the processing device may be configured for obtaining at least one second information associated with an engagement of the at least one second user through the at least one user interface of the at least one platform from the at least one second user device. Further, the processing device may be configured for analyzing the at least one second information. Further, the processing device may be configured for generating the at least one reward for the at least one second user based on the analyzing of the at least one second information. Further, the storage device may be communicatively coupled with the processing device. Further, the storage device may be configured for storing the at least one second information.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method 200 of provisioning experiences for enhancing engagements, in accordance with some embodiments.

FIG. 3 is a flowchart of a method 300 of provisioning experiences for enhancing engagements, in accordance with some embodiments.

FIG. 4 is a flowchart of a method 400 of provisioning experiences for enhancing engagements, in accordance with some embodiments.

FIG. 5 is a block diagram of a system 500 for provisioning experiences for enhancing engagements, in accordance with some embodiments.

FIG. 6 is a block diagram of the system 500, in accordance with some embodiments.

FIG. 7 is a block diagram of the system 500, in accordance with some embodiments.

FIG. 8 is a block diagram of the system 500, in accordance with some embodiments.

FIG. 9 is a screenshot of a user interface 900 of an application for scanning a QR code for provisioning experiences for enhancing engagements, in accordance with some embodiments.

FIG. 10 is a screenshot of a user interface 1000 of the application for signing up, in accordance with some embodiments.

FIG. 11 is a screenshot of a user interface 1100 of the application for claiming collectibles to earn points in an experience, in accordance with some embodiments.

FIG. 12 is a screenshot of a user interface 1200 of the application for keeping track of points and activities, in accordance with some embodiments.

FIG. 13 is a screenshot of a user interface 1300 of the application for displaying a history of attendances and interaction of a user, in accordance with some embodiments.

FIG. 14 is a screenshot of a user interface 1400 of an interactive map of the application, in accordance with some embodiments.

FIG. 15 is a screenshot of a user interface 1500 of the interactive map of the application, in accordance with some embodiments.

FIG. 16 is a screenshot of a user interface 1600 of the interactive map of the application, in accordance with some embodiments.

FIG. 17 is a screenshot of a user interface 1700 of an application for scanning a QR code for provisioning experiences for enhancing engagements, in accordance with some embodiments.

FIG. 18 is a screenshot of a user interface 1800 of the application for claiming a collectible, in accordance with some embodiments.

FIG. 19 is a screenshot of a user interface 1900 of an application for scanning a QR code for provisioning experiences for enhancing engagements, in accordance with some embodiments.

FIG. 20 is a screenshot of a user interface 2000 of the application for signing up, in accordance with some embodiments.

FIG. 21 is a screenshot of a user interface 2100 of the application for recording activities, in accordance with some embodiments.

FIG. 22 is a screenshot of a user interface 2200 of an application for scanning a tag comprised in a garment for provisioning experiences for enhancing engagements, in accordance with some embodiments.

FIG. 23 is a screenshot of a user interface 2300 of the application for keeping track of points, perks, and places, in accordance with some embodiments.

FIG. 24 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for provisioning experiences for enhancing engagements, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number stored on a smartcard with an authentication token which is the technology of the smart contract. Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods, systems, apparatuses, and devices for creating events for enhancing engagements.

Further, the present disclosure describes a gamified fan engagement solution via Web3 for helping brands grow and connect with their audiences through customizable loyalty programs and immersive experiences including a scavenger hunt initiative. Further, the gamified fan engagement solution engages customers in interactive activities while providing customer engagement data to enrich brands' customer databases. Further, the brands may be a company, an entity, etc. Further, the brands may be associated with a product, a service, etc.

Further, the present disclosure describes providing real first party data on each user interaction with physical and digital content, service, and/or physical goods. Brands have access to data on the most engaged customers, information on who those customers are, and their demographics. Brands with this data can maximize the value of their marketing dollars and target loyal customers. There is a big gap in the global market for a technology that is able to provide first party data on every step of customer interaction with the brand. Further, the information of the user (such as a customer) is narrowed down to each user interaction with each water can, cocktail order, parking spot, and product giveaway.

Further, the present disclosure describes the gamifying of the purchase and/or usage of services and physical goods. Customers get rewarded points for every single interaction with the brand and are able to track the number of points, as well as their ranking. Brand interactions can be in the physical world, for example: users scan the QR codes on water cans, which unlock points in their personal wallets. Brand interactions can also be tracked in the digital world, for example: a user shares a social media post and gets points. There are always clear rules set in the solution indicating the number of points that have to be collected in order to unlock a reward.

Further, the present disclosure describes a scavenger hunt initiative that helps to further gamify the whole process for brands. The digital interactive map showcases every single location (including restaurants & bars, events, art galleries, and conferences) where points can be collected and the number of points available. It also functions as a marketing tool, where sponsors can purchase a listing and become a location on the map. This way the scavenger hunt brings more physical traffic to those locations and rewards participants for visiting or interacting with those locations on the map. It is an easy and cost effective process for brands to raise more awareness and attract new customers. Further, first party data on who interacted with their brand and who had the highest level of interaction is provided to the brands. Brands can use this data to continue targeting those new customers and retaining them as loyal customers. Further, the scavenger hunt allows the collecting of data from each map location to provide heat analysis data, depicting the most popular locations or events. This solution functions as a guide for participants to follow and visit the hottest events, parties, and restaurants, whilst being rewarded for it. There is currently no analog to this initiative in the market. The fun quest game has been turned into a tool to incentivize local communities to visit specific locations and support brands or events via their engagement. Further, this solution creates a new and cost friendly opportunity for brands with low marketing budgets to be able to get involved and generate more awareness about their products or services.

Further, the present disclosure describes an Alphaa Loyalty Suite of Alphaa.io. Further, the Alphaa Loyalty Suite is a big solution that encompasses Alphaa Passport and Alphaa Fingerprint. Alphaa Loyalty Suite is based on four categories: Badges, Points, Things, and Access. Each of these products helps solve a unique need in the loyalty ecosystem and works with each other to provide a seamless, integrated engagement platform for brands and customers.

Further, the present disclosure describes providing a tailored loyalty solution that would work the best for the client's needs. Further, the tailoring of the loyalty solution comprises figuring out what are the points, things, access, and badges that make sense for a particular brand. For example for customer product goods (CPG) brands the ‘points’ can be called shots and ‘things’ are the beverage bottles.

The Badges are the brand's unique currency represented by an icon of choice symbolizing value and rewards. They are rewards unlocked for performing a certain activity, such as visiting a geo-fenced location, sharing a post on social media, or earning over a certain number of points. These are all activities that users are participating in, after which successfully completing they unlock a badge.

The points function analogously to a form of currency. In essence, each brand develops a unique symbol or icon to represent this currency, further defining it with a specific name and description. For instance, Cryptobros utilizes a golden coin, designated as “Points”, while Ape Water employs the term “Bananas” for their form of currency. Points are earned for completing actions, such as purchasing products or visiting brand events. For every engagement with the brand, users earn points. Earning points brings users closer to rewards.

The things encapsulate all tangible or intangible items that an end user can acquire through various means such as claim (free Thing), buy (paid Thing), achieve (badges), win (prizes), etc. For example, for a chocolate brand a ‘thing’ would be one of the chocolate flavors sold by the brand. The things are non-fungible, meaning they maintain distinct identities and do not merge with one another, even if they belong to the same category. The process of acquiring a “Thing” might generate points, and if it does, these points remain with the user even if the corresponding asset is sold or transferred. On the other hand, users can utilize or liquidate their points without forfeiting their “Things”.

The access category is similar to “Things” but is specially designed to ensure exclusive privileges or permissions, either physical or digital. These could range from admission to an event, an exclusive session on a website, or even a one-of-a-kind experience. The aim here is to provide a differentiated, unique value proposition to users. Access also takes into account experiences that need to be accessed from a specific location (geofenced). Access categories can take many forms and are highly dependent on the context of the brand or service. For example, an “Access” in a music streaming platform could be an exclusive online concert or early access to new releases from popular artists.

Further, Alphaa.io's loyalty program can integrate with a sales company like Shopify, implement AR characters of individuals, add impact trackers, offer phygital tokens, build custom wallets, and more. Further, data reports on the number of users, information about those users, and the number of times they interacted with a specific location or experience and more may be provided to the users.

Further, the present disclosure describes the scavenger hunt feature which elevates the loyalty program of each brand, by gamifying the consumer experience and rewarding them for playing the game. Players of the game have clear goals to reach in order to win the game. The interactive map showcases exactly how many locations participants need to go to and how many points are available to be claimed at each location. People can also track their ranking in the game and a total number of points collected. For CPG brands, the locations on the map are all the retail locations where the products of the company are sold. Customers follow the map and use it as a guide to go to these locations and discover new restaurant spaces where they can try the products and retail stores. The scavenger hunt feature is a great way to boost foot traffic to physical locations. There can be multiple partner brands coming to one event or a city wide activation. Sponsors purchase a listing on the map and in return get access to first party data on people who interacted with their brand, as well as brand exposure to thousands of new customers. This is the easiest way for companies to market their brands for very low costs. There is currently a big roster of clients in the pipeline, who want to be involved. The scavenger hunt map includes multiple locations such as events, art galleries, CPG brands, etc. The participant needs to go to these locations. Points can be collected by scanning a QR code or clicking a link, which directly opens the loyalty experience for the user. After scanning the QR code, the customer will sign up for the personal wallet via an email or phone number. This will grant customers access to the experience and allow them to track all the points they have collected in the experience so far and where they were collected. The experience is similar to having stamps in your passport, as customers get stamps for every interaction.

The QR code can be scanned from anywhere: TV screens, posters, videos, etc. Additionally, for app integration or POS providers similar to Shopify, users can collect points for their purchases or engagements on the platforms. For example, a user can earn points in his personal wallet for listening to a podcast on a podcast application. Similarly, users can earn points for purchasing wine bottles on the web2 platform.

Further, the present disclosure describes a software for providing the gamified fan engagement solution. Further, the software is easy to use as anyone can activate their personal branded wallet via an email or phone number. Further, the software has easy integration and implementation as the software may be integrated with any app, website, existent tokens, etc. Further, the software is flexible because the software may be made only available in web2 form or only in web3 based on the client's demands. Further, any minting engines of preference may be used with the software. Further, Shopify providers may be added to the software. Further, the product may be activated and used anywhere in the world. Further, the product may be easily implemented in all physical locations such as events, restaurants, CPG brands, conferences, crowdfunding initiatives, billboards and posters, and fashion shows. Any place where users may scan a QR code. Further, the product may be easily implemented in the digital world. Further, the product can be activated via physical garments. Further, the product offers a cost friendly marketing strategy for brands: such that more brands can afford to market their product by purchasing a listing on the scavenger hunt map. Further, the product brings real first party data to clients and sponsor brands.

Further, the present disclosure describes fan engagement solutions that empower brands to connect with their audiences through immersive digital experiences. Tailor-made packages of the fan engagement solutions offer tokenization, smart contracts, digital assets, customizable loyalty programs, access to a worldwide network of founders and funders, and more, all stored securely on Blockchain. The fan engagement solutions help brands grow and track fan bases, revolutionizing the way businesses interact with their followers

Alphaa.io (Alphaa) is designed to help brands connect with customers by creating solutions that generate engagement and allow customer data collection. Our dynamic ecosystem opens doors for smaller enterprises to access the next level of brand exposure, an opportunity previously beyond their reach. Simultaneously, we empower both smaller and larger companies with white-label loyalty management solutions, ensuring a mutually beneficial relationship between brands and customers that transcends conventional boundaries.

Alphaa.io offers a holistic loyalty program and engagement ecosystem that directly connects customers and brands. Interactive activities engage customers while providing customer engagement data to enrich brands' customer databases. Alphaa.io's solutions are more than loyalty; they create a community that is connected, dynamic, and mutually beneficial to both brands and consumers.

For brands that are part of its loyalty ecosystem, Alphaa.io seamlessly employs gamification for new client acquisition and retention, deepens consumer engagement through unique and meaningful brand experiences, and harnesses the power of first-party customer data to optimize marketing expenditures. This ensures that every dollar invested delivers maximum impact, all while customizing the experience to perfectly align with a brand's unique identity and objectives.

Within the Alphaa.io ecosystem, brands can also become event sponsors. Alphaa.io ecosystem allows companies to connect to sponsorship opportunities that once were not accessible. Alphaa.io sponsors that participate in Alphaa.io's Passport and Sponstar programs are able to maximize their marketing ROI and gain unparalleled access to valuable first-party customer data. By precisely targeting events to individuals aligned with their interests, Alphaa.io enables high client retention, ensuring that sponsors invest wisely in engagements that resonate with their ideal audience, resulting in optimized marketing dollars and lasting brand impact.

For new and existing customers of brands in Alphaa.io's loyalty ecosystem, Alphaa.io offers personalized brand experiences, where engaging interactions, gamification, enticing rewards, and clear, achievable goals converge. As a valued member of a brand's loyalty program, customers not only reap tangible benefits but also enjoy a sense of recognition, making their brand journey uniquely fulfilling and enriching. Alphaa.io's ecosystem enables access to free products, VIP experiences, and quality benefits.

To enable the ecosystem to work under a unified currency, Alphaa.io is launching its token (the technology behind the smart contract) and introducing Alphaa coins. Brands can reward customers through Alphaa coins, which can be redeemed with any of the brands that are part of the unified point system. On the other side of the ecosystem, tokenization will allow Alphaa.io to break huge sponsorship packages into tokens, making big Tiers more accessible. In this way, Alphaa.io creates unique value for brands, customers, and sponsors.

Alphaa.io has created a Web3 loyalty and engagement ecosystem that consists of three products: Alphaa Passport, Alphaa Fingerprint, and Sponstar, all supported by blockchain technology. Each of these products helps solve a unique need in the loyalty ecosystem and work with each other to provide a seamless, integrated engagement platform for brands and customers. Leveraging blockchain technology, Alphaa.io leads the development of a robust trading ecosystem by implementing tokenization. This ensures a cost-efficient infrastructure and also upholds the integrity and credibility of the data involved.

Alphaa.io's Passport is a versatile loyalty program that features a city-wide scavenger hunt powered by geofence technology and cutting-edge QR codes. The interactive map boosts foot traffic to local events and exhibitions while providing organizers with valuable insights into their community. Passport holders receive exclusive curated programming and exclusive access across partner events and brands. Each location boasts special commemoratives and rewards, offering participants the chance to win exclusive invitations and VIP access.

Passport's key features include Multi-exhibition scavenger hunts, access to sponsored events, interactive QR codes, points rewards for visiting events & exhibitions, verified proof of attendance, Global art world community, and Passport-holder data for galleries and events. Each visit grants one more passport stamp towards unlocking exclusive perks, prizes, and VIP access. Users collect commemoratives for visiting participating galleries, art fairs, art events, public art locations, and parties during Passport affiliated events. Passport holders unlock badges after they acquire a certain number of stamps. Badges provide access to VIP perks, prizes, and more. The Passport holders with the most badges reach an exclusive status. Starting with the basic Free Listing all the way up to the exclusive Title Sponsor listing, we offer a sponsorship tier for every need. All sponsorship options are flexible and can be tailored to accommodate your specific needs and budget.

Alphaa Fingerprint is a solution that aggregates all user data and interactions within the product. Each user has a punchcard that never expires, guaranteeing access to the customer journey within brands.

Alphaa.io's technology architecture is meticulously designed to ensure scalability, security, and seamless user experience, leveraging state-of-the-art technologies and services. Alphaa.io uses an Ethereum layer 2 blockchain network built on the decentralized foundations of Ethereum. Its carbon neutral infrastructure serves a wide range of applications, including gaming, tickets, metaverse, identity, and enterprise systems, making it the perfect match for our many projects. The foundation of blockchain lies in its reliability and credibility, critical elements for a successful transaction. By tokenizing loyalty points (Alphaa points) we can not only ensure secure and reliable transactions but also facilitate effortless transfers and exchanges across various services without the need for subsequent settlements among companies. This structure allows the customers to navigate into different brands in the same ecosystem. Additionally, by tokenizing loyalty points, we allow users to transfer Alphaa Coin to external crypto exchanges, providing an avenue for cashing in on its benefits.

Sponstar is an innovative marketplace for fractional sponsorship. It works as an investment platform that democratizes access to large sponsorship pools through fractional shares. Sponstar gives access to fractional shares of large sponsorship pools that can be tailored to suit any marketing campaign. The solution gives access to diversified opportunities and real-time data, producing real ROI. The sponsor can, within a certain time frame, resell their slots for an appreciated price. The marketplace shares a list of events and satellite events, providing a platform for potential sponsors to join relevant listings. Brands engage by purchasing a sponsorship block for a specific event, with the option to choose a listing event, or just by buying an amount of token to invest in future opportunities. Sponsors have the flexibility to determine their level of participation, specifying details such as the amount of product donation, prizes offered, and listing locations. As the event approaches, the sponsorship block accumulates value, creating a dynamic investment. The value of the sponsorship opportunity extends beyond the event itself, potentially continuing for consecutive events. Sponsors have the option to resell their listing within a specified timeframe and at an agreed-upon price.

Although the Alphaa.io ecosystem is very robust, Alphaa.io differential also relies on simplicity and transparency: the experience of the end-user is pretty easy. From a QR Code Scan or an accessible link, it's only one click to a wallet creation with an email or phone number, and the customer is ready to interact with the whole Alphaa.io Ecosystem—no need to download any apps, accessible from anywhere.

A similar logic applies to the context of Sponstar: Blockchain technology is the key to allowing the traceability, automatization, and security we need for this solution to work. The tokenized sponsorship slots allow firms to purchase fractions of big sponsorship packages with the option to resell them in the future while maintaining a comprehensive record of the entire selling process, allowing tracking resale royalties.

Further, the present disclosure describes a scavenger hunt. Further, the scavenger hunt provides an immersive experience for revolutionizing audience engagement. Further, the scavenger hunt seamlessly blends physical and digital elements with an easy-to-use interface, delivers unforgettable moments, exclusive earnings, and prizes builds lasting loyalty, and optimizes a fanbase. Further, the scavenger hunt may be used to collect unique user data ethically and securely.

Further, the scavenger hunt of Alphaa.io incentivizes user engagement and brings foot traffic to physical locations. Further, the scavenger hunt drives foot traffic to CPG brands, Art events and galleries, restaurants and bars, fashion shows and merchandise stores, sports teams, etc.

Further, the scavenger hunt may include boosting brand awareness. More people learn about the participating brands through the map. Further, the scavenger hunt may provide heat map analysis. The heat map analysis provides information on locations with high foot traffic. Further, the scavenger hunt may be used to collect user data. The data may include real data about users: name, email, phone number, and locations visited. Further, the scavenger hunt may build a community. Further, the community brings together participants with fun incentives and team challenges.

Further, the scavenger hunt can be implemented as an interactive map or via QR codes displayed, scattered around an event, or held at one location. The maps and QR codes can also be distributed via creative marketing strategies, social media, influencers, or digital platforms. Further, the geofenced scavenger hunt may be deployed any where. Further, the user may show up, check in, and claim tokens to unlock prizes and win.

Further, the QR code activation of the scavenger hunt may include finding QR code, scanning QR code, one-click-link signing up with an email or phone number, and claiming a token which involves adding points to the wallet. The player with the most points wins.

Further, the scavenger hunt may employ geolocation technology to track devices in real time and provide data. Further, the scavenger hunt is built securely on blockchain.

Further, the present disclosure describes gamifying consumer packaged goods (CPG). Further, the gamifying of the CPG by the Alphaa.io boosts consumer engagement. Further, the gamifying of the CPG may be associated with things, points, and places. Further, the things may be physical and digital. Further, the points may be used for impact tracking and cashback. Further, the places are used for providing experience and access to locations.

Further, the gamifying of the CPG boosts brand awareness. The digital product increases awareness of physical goods. Further, the gamifying of the CPG may be used for loyalty tracking. Loyalty tracking involves track when and where the brands' top consumers are spending. Further, the gamifying of the CPG may be used for collecting user data. The data may include real data on users: name, email, phone number, locations visited, etc. Further, the gamifying of the CPG may be used for reward engagement. Consumers win tokens with every purchase & unlock exclusive utilities.

Further, the user journey in the gamifying of the CPG may include signing up. The user may scan QR code on the product to start collecting points and compete for big prizes. The user may enter the program from any QR code (on site, on product, physical event, link in newsletter, etc.). Further, the user journey in the gamifying of the CPG may include collecting tokens. The user may collect a new token and earn points with every product the user purchases. Further, the user journey in the gamifying of the CPG may include completing challenges. The user may unlock tokens with activities like recycling challenges, scavenger hunts, and more. Further, the user journey in the gamifying of the CPG may include winning prizes. Further, the user may use tokens to unlock exclusive prizes.

Further, the gamifying of the CPG involves a use of a paperless passport. Further, the paperless passport easily tracks users' purchase history. Further, the paperless passport logs the user's activity in one place to unlock rewards when the users make a purchase or complete a challenge.

Further, the gamifying of the CPG involves QR code activation. The QR code activation may include finding QR code, scanning QR code, one click link for signing up with an email or phone number, claiming a token to add points to a wallet, learning about the product, and earning points and unlocking rewards.

Further, the QR code unlocks tokens for physical products for claiming points. Further, the claiming points include scanning QR codes on products to add tokens to the wallet. Further, each token includes unique information about product make and history. Further, the tokens unlock points that can be used for discounts, exclusive invites, phygital merchandise, and more.

Further, the points may be earned from D2C purchases. Further, earn points on online retail purchases like Amazon and redeem them later. After making a purchase, customers receive a link to automatically claim the token into their wallets.

Further, the gamifying of the CPG involves in-person experiences for participation and collection. Further, the in-person experience may include scavenger hunts and one time events. Further, the user may collect points with scavenger hunts at participating store locations. Further, the one time events promote user engagement through commemoratives at product launches, store openings, etc.

Further, QR codes encourage consumers to visit physical stores and purchase products. After purchasing products from X number of stores, customers unlock special rewards such as a free trip abroad. Store of the week: different stores can be activated each week.

Further, the data may be collected through the gamifying of the CPG. The data may be site-specific, QR-code-specific, and player-specific data. The data may be used for unlocking valuable insights. Further, the data may include in-person events information, checkpoint interaction, performance metrics, player engagement, user feedback, and retailer information.

Further, the gamifying of the CPG includes impact trackers that encourage sustainable consumption. Further, the impact tracker tracks recycling program activity, fundraising goals, number of purchases, sustainability markers, etc.

Further, the present disclosure describes seamless crowdfunding for films. The seamless crowdfunding for the films may be employed using a full application suite that connects with a large number of investors. The application also removes friction, builds trust, unlocks new value, and captures more people. The application provides a tokenized platform to connect with the production team as well as investors' success.

Further, the seamless crowdfunding for the films may use NFT to fund the film. Further, the NFT holds smart contracts to validate investment and involvement in production. Marketing tool to quickly and easily raise more funds for the film.

Further, the user journey in the seamless crowdfunding for the films may include activating a crowdfunding wallet. Further, the user may scan QR codes via crowdfunding events, promotional videos, advertising, and movie material. Wallet activated by the QR code or link. Further, the user journey in the seamless crowdfunding for the films may include choosing a funding package. There are funding packages for every need and perks are personalized per package. Further, the user journey in the seamless crowdfunding for the films may include NFT Ownership. NFT comes with a funding package. NFT validates holder's fractional ownership of the film. Further, the user journey in the seamless crowdfunding for the films may include unlocking utilities. NFT holders access perks related to the amount of investment. The perks accessed by the NFT holder may include an invitation to the premier, voting rights on who gets cast, role in the film, etc.

Further, the seamless crowdfunding for the films involves wallet activation via a QR code. Further, the wallet activation includes scanning the QR code, signing up with a one-click link, claiming NFT to fund film, and tracking NFT utilities and perks unlocked.

Further, the NFT holders can unlock invitations to the film premier, invitations to exclusive events, voting rights on casting, decisions on the storyline, having a part in the film, meeting the cast, setting visitations, etc.

Further, there are different tiers levels and fans may choose the type of NFT to purchase. Further, a gold type of NFT provides invites to the events, production visitation, and welcome package, voting rights on casting, and having a say on how the movie should end. Further, a silver type of NFT provides invites to all of the events, production visitation, and welcome package, a small acting part in the film, and a chance to get invited to the premier. Further, a bronze type of NFT provides invites to select events, production visitation, and a welcome package.

Further, the NFT has special designs. Further, each NFT funding package will have a creative design made by an accredited artist.

Further, the NFT may be used at physical/digital events and locations. Further, the NFT may be used at conferences and crowdfunding events where the QR code is displayed on a screen or posters throughout the event. Attendees receive a link to activate their wallet and purchase NFT. Further, the NFT may be used in billboards, promotional content, and banners where the QR code is displayed on any printed material to scan and purchase NFT. Further, the NFT may be used in trailers, movie clips, and videos where the QR code at the end or throughout a video Users scan and activate the wallet to fund the movie. Further, the NFT may be used on social media and websites where a wallet is activated via a link on social media posts. Further, the benefits may include activation from anywhere, quick sign up, simple onboarding, capturing a big audience, etc.

Further, the data may be collected through the seamless crowdfunding for the films. Further, the data unlocks valuable insights. Further, the data may include registration information, checkpoint interaction, performance metrics, successful and unsuccessful crowdfunding campaigns, user feedback, etc. Further, the data may be site specific, QR code specific, and user specific data.

Further, the present disclosure describes gamifying fashion week. Further, the gamifying of the fashion week provides immersive experiences that transform the way customers interact with brands. Further, the brand community is built around things, points, and places. Further, the gamifying of the fashion week is performed using a tokenized platform that is used to interact with brands and designers.

Further, the gamifying of the fashion week involves the use of a fashion week passport. Further, the fashion week passport allows the community to engage with the brand through immersive phygital experiences, scavenger hunts, etc.

Further, the user journey in the gamifying of the fashion week includes scanning a QR code. The user may scan the QR codes at store booths. The user may scan clothing worn by models on the runway to unlock information & rewards. Further, the user journey in the gamifying of the fashion week includes claiming collectibles. After scanning the QR code the user may claim a collectible and receive an experience, exclusive information, etc. Further, the user journey in the gamifying of the fashion week may include collecting points. The scanning of the QR code automatically unlocks points. The number of points varies depending on the QR code. Further, the user journey in the gamifying of the fashion week may include unlocking exclusive rewards. When users collect a certain amount of points, they receive exclusive rewards such as an exclusive bag or a discount at the brand's store.

Further, the gamifying of the fashion week may include QR code activation. Further, the QR code activation may include finding the QR code at different store locations, scanning the QR code, one-click-link for signing up with an email or phone number, claiming tokens to add points to the wallet, learning about the brand and its mission, and earning points and unlocking rewards.

Further, the gamifying of the fashion week may include QR code activation on garments. Further, the participants scan each runway look to unlock information about the piece and activate experiences. The NFC chips attached to the runway look. Further, tapping the NFC chip unlocks points and information. Further, the NFC chip opens mobile experiences and challenges.

Further, the activation enriches the fashion show experience for the audience and brands. For participants, it provides an opportunity to win rewards, interaction with different brands, and participate in the fashion show. For brands and designers, complimentary tech consultation for designers, 1 brand activation up to $5 k value, and data on people who are curious about their brand (with email addresses).

Further, the user may redeem benefits through points. Further, the user may collect points to unlock discounts at participating stores, runway show tickets, gift packages, VIP access, meet and greet with designers, access to events, collectibles, etc.

Further, the data may be collected through the gamifying of the fashion week. The data may be store-specific, QR-code-specific and customer-specific data. Further, the data may be used for unlocking valuable insights from activation. The data may include information on participants, including their emails, phone numbers, and more, interactions with products, most popular products, purchasing trends, user feedback, etc. Further, the gamifying of the fashion week includes an animated AR experience in which AR footage of real life people is available for digital use and characters can be made to talk and move in any shape or form. The whole experience makes it feel realistic.

Further, the present disclosure describes gamifying life. Further, the gamifying of the life by Alphaa.io boosts fan engagement. Further, the gamifying of the life may be associated with things, points, and places. Further, the things may be physical and digital. Further, the points may be used for impact tracking and team currency. Further, the places are used for providing geofenced experience and access to locations.

Further, the gamifying of the life may be employed using a full application suite that connects with fans. The application also removes friction, builds trust, and unlocks new value with the fan base. The application provides a tokenized platform to interact with teams.

Further, the gamifying of the life dynamic involves the use of player cards. Further, the player cards are linked to real player stats. The player card has information about the player history such as the number of games, stats, injuries, etc. Further, the player tokens may be purchased at the beginning of the game season or claimed after completing the trivia challenge. Further, the number of points collected changes depending on players' performance. Further, the player NFTs can be traded between fans, and extra points are awarded for social shares. The person with the best player performance at the end of the season wins a big prize.

Further, the user journey in the gamifying of the life may include obtaining the player cards. The player cards are obtained through trivia challenges and geofenced experiences: stadium visits, merchandise stores, and scavenger hunts. Further, the player card may be obtained from a pack of random cards. Further, the user journey in the gamifying of the life may include tracking players' performance. The player card value adjusts with the real time performance of the player. Further, the cards are stored in RBFA app (seamless log-in, without the need to download new apps). Further, the user journey in the gamifying of the life may include completing card collection through multiple geofenced experiences, trivia challenges, and trading cards with other fans. Further, the user journey in the gamifying of the life may include unlocking exclusive rewards by collecting an entire team and having player cards with the best stats.

Further, the fans benefit through VIP access, exclusive perks and merchandise, first access to tickets, fan community, and custom fan player cards. Further, the players benefit by connecting with the fanbase, custom merchandise, having a card with an image, and resale royalties. Further, the team benefits by engaging fans online and in real life, obtaining fan community data, increasing revenue with trading cards, an increase in brand awareness, and resale royalties.

Further, the data may be collected through the gamifying of the life. The data may be site-specific, QR-code-specific, and player-specific data. Further, the data may be used for unlocking valuable insights from scavenger hunts. Further, the data may include registration information, checkpoint interaction, performance metrics, player engagement, and user feedback.

Further, the gamifying of the life may include home trivia for unlocking player cards. Further, home trivia involves watching a game, scanning the QR code on the screen for playing, answering fun trivia questions about the game, and completing a trivia round to unlock a player card in a dashboard.

Further, the gamifying of the life involves geofenced experiences which include participating in scavenger hunts at the stadium and surrounding areas for finding player cards and unlocking special player cards by purchasing team merchandize or participating in in-stadium games.

Further, the user may redeem benefits by completing a team of the benefits with a complete team of player cards. Further, the complete team of player cards unlocks early access to games, priority ticket purchases, discounted ticket prices, merchandise package, VIP lounge access at games, meet-and-greet with the team, and red insider membership discounts. The player cards hold all player information such as the number of games played, number of goals, position on the field, injuries, average speed, number of cups won, and fouls. There are customized player cards which are customized with artistic designs. Each player has 6 metrics for stats such as pace, acceleration, spring speed, dribbling, shooting, defending, passing, and physicality. Further, the final score per player depends on the position on the field with a maximum score of 99. Further, one of the existing formula tables is chosen and deployed for the player cards. Further, the metrics for the player may be user defined formula. Further, the key information regarding the metrics includes updating of player metrics in real time, the maximum player score of 99, score depends on the field position and ad-hoc weights, formula examples for center forward: scoring frequency*33%+key passes*33%+Accuracy per game*33%, formula changes per position in the field.

Further, the present disclosure describes gamifying the world. Further, the gamifying of the world involves the use of a passport of Alphaa.io. Further, the passport may be used for a versatile loyalty program for the art community that offers rewards and accreditations across events and exhibitions through a seamless digital passport system. Further, the gamifying of the world is a curated experiential solution to drive traffic to physical locations. Further, the passport is a paperless passport. Further, the passport has features such as multi-exhibition scavenger hunts, access to sponsored events, interactive QR codes for artwork, points for visiting events & exhibitions, verified proof of attendance, global art world community, and passport-holder data for galleries and events.

Further, the passport may be used for collecting art stamps. The users collect commemoratives for visiting participating galleries, art fairs, art events, public art locations, and parties at a physical location hosting an art fair. Each visit grants one more passport stamp towards unlocking exclusive perks, prizes, and VIP access.

Further, the benefits for patrons may be unlocked prizes, a curated list to follow, immersive activities, community connection, custom wallet, and store activity in one place. Further, the benefits for institutions may be boost engagement, expand audience, encourage in real life (IRL) visits, art world collaborations, digital add-ons to artwork, and commemoratives for visits. Further, the benefits for art fairs may be sponsorship opportunities, exclusive member data, geofence scavenger hunt, commemorate events, VR and AR supplements, and connect all galleries.

Further, the user journey for the art passport holder experience may include scanning the QR code on site to sign up with an email or phone number zero membership fees, activating the Art Passport wallet & claiming collectibles attached to the QR code, recording all artworks & events on personalized Art Passport dashboard, start exploring which include adding points to the passport with every QR code scanned, and redeeming points for invitations to private viewings, VIP access, exhibition previews, etc.

Further, the gamifying of the world with respect to art fairs, gallery openings, exhibitions, and events include:

1. Listing a location: Locations featured on Art Passport's directory receive a QR code plaque to place at the physical location for no fee.

2. Reaching worldwide art community: Digital & physical marketing across locations. Passport-holders compete to scan QR codes at galleries and events.

3. Exclusive attendee data: Participating locations receive QR code data on visitor activity, as well as art pieces that received the most interaction.

4. Activate and expand network: Passport-wide access to a network of art world insiders, a master roster of clients, and QR code user data across locations.

Further, the gamifying of the world includes a scavenger hunt for art. Further, the scavenger hunt for art includes scavenger hunt interactive map and site-specific QR codes. Further, galleries and art events are displayed on the map for people to visit. Further, QR codes are placed on site to boost visitor engagement. Further, the visitor data is received at these locations. Further, the scavenger hunt for art involves using geolocation technology to track a device in real time and provide key data. Further, the scavenger hunt is built securely on blockchain.

Further, the gamifying of the world involves QR code activation. Further, the QR code activation may include finding a unique QR code, scanning the QR code, one-click sign up via email or phone number, claiming collectible & adding points to the wallet, and unlocking awards with every visit.

Further, the data may be collected through the gamifying of the world. Further, the data may be used to increase sales, foot traffic & marketing. Further, the data may be site-specific, QR-code-specific, and player-specific data. Further, the data may include registration information, checkpoint interactions, performance metrics, artwork engagement, user feedback, and art passport activity.

Further, the gamifying of the world may be associated with a unified Alphaa.io point system. Further, under the unified Alphaa.io point system, there are collaborations between locations, a unified point system across locations, customized data sets for all locations, and cross community validity of rewards & perks.

Further, the present disclosure describes gamifying real life (IRL) events. Further, the gamifying of the IRL events includes gamifying the conference experience. The gamifying of the conference experience shifts attendees from being spectators to participants of the conference. Further, the gamifying of the conference experience includes an interactive, conference-wide scavenger hunt via map or QR codes. Further, the gamifying of the conference experience boosts engagement, educates attendees, and builds long-term community. Further, the gamifying of the conference experience allows attendees to scan QR codes throughout the venue to collect points and win prizes.

Further, the gamifying of the conference provides an immersive experience for revolutionizing audience engagement. Further, the immersive experience is provided by combining physical and digital elements with an easy-to-use interface, delivering unforgettable moments, building lasting loyalty, optimizing fanbase, and ethically and securely collecting unique user data.

Further, the gamifying of the conference boosts brand awareness by sharing information about the conference and speakers via games. Further, the gamifying of the conference allows for heat map analysis to identify high foot traffic locations. Further, the gamifying of the conference allows collecting user data which may be real data on users: name, contact info, and activity. Further, the gamifying of the conference may build a community where attendees keep playing at home and future events.

Further, the user journey in the gamifying of the conference may include looking for QR codes and scanning the QR code. The QR code posters are throughout the conference and players scan to compete to win the most points. Further, the user journey in the gamifying of the conference may include claiming collectibles and earning points. Each poster depicts a festival speaker character. Attendees learn about the speaker and collect points. Further, the user journey in the gamifying of the conference may include tracking progress. Participants can track the number of points collected and their ranking. The player profile of the player is customizable. Further, the user journey in the gamifying of the conference may include winning prizes. The player with the most points wins a big prize.

Further, the benefits of the gamifying of the conference include boosting customer engagement. Attendees can now be more involved in the conference and engage further with the overall brand. Further, the benefits of the gamifying of the conference may include education. Each character collected is connected to a speaker of the conference or an important persona, telling a specific message related to the conference. Further, the benefits of the gamifying of the conference include entertainment. The game is a way to entertain the attendees, as they await the next speaker or if there are any delays in schedule. Leading to overall higher customer satisfaction.

Further, the winners of the game unlock exclusive prizes such as one-on-one with a speaker of their choice, an opportunity to be a speaker at next year's conference, sponsored gifts such as event tickets, merchandise, products and more, and discounts and early offers on conference tickets and products.

Further, the gamifying of the conference may involve custom characters. The characters are illustrated versions of conference speakers and sponsors. Each character features key information about the subject character design is fun and resembles the speaker. The different characters are worth a different number of points.

Further, the gamifying of the conference may drive traffic. Further, the traffic is driven by a geofenced scavenger hunt. The participants show up, check in, claim tokens to unlock prizes and win. Further, the scavenger hunt is implemented as an interactive map or as QR codes placed throughout the event location.

Further, the gamifying of the conference may be associated with a unified point system. Further, the point system in the integrated wallet allows users to use points beyond the scavenger hunt experience, across the platform.

Further, the gamifying of the conference may involve QR code activation. Further, the QR code activation may include finding a QR code at an event, scanning the QR code, a one-click link for signing up with an email or phone number, and claiming tokens by adding points to the wallet. The player with the most points wins.

Further, the user journey in the gamifying of the conference may include finding signage at the conference and scanning a QR code to start playing. Further, the participants aim to visit many different locations to collect points. Further, the points can be collected by scanning a QR code at each location. The points may be collected to claim prizes, access to events, etc. Further, there are different tier levels. The next tier level gets trading credits. The person with the most number of points collected wins the prize. The winner gets a full prize package.

Further, the present disclosure provides a solution to the technical problem of enhancing user engagement. Further, user engagement may be enhanced by incentivizing user engagement through rewards. The rewards are provided by measuring the engagement of the user with a brand through an experience. The experience is provisioned by generating a user interface that prompts the user to perform certain activities by leveraging a return of investment information from the brand and curating the user interfaces that would prompt certain activities. The user receives the experience by performing the activities. The performing of the activities leads to user engagement.

The user engagement is also enhanced by leveraging the data of the user which includes social media data and personal data to determine the preference of the user. The activities are then determined which are tailored to the preference of the user. The user interface generated based on these activities enhances user engagement since the activities are tailored to the user.

The user engagement is also enhanced by gamifying the activities. The gamifying of the activities involves a scavenger hunt. The gamifying of the activities may include providing an interactive map of an area having multiple locations and the user interacts with the one or more locations to earn rewards.

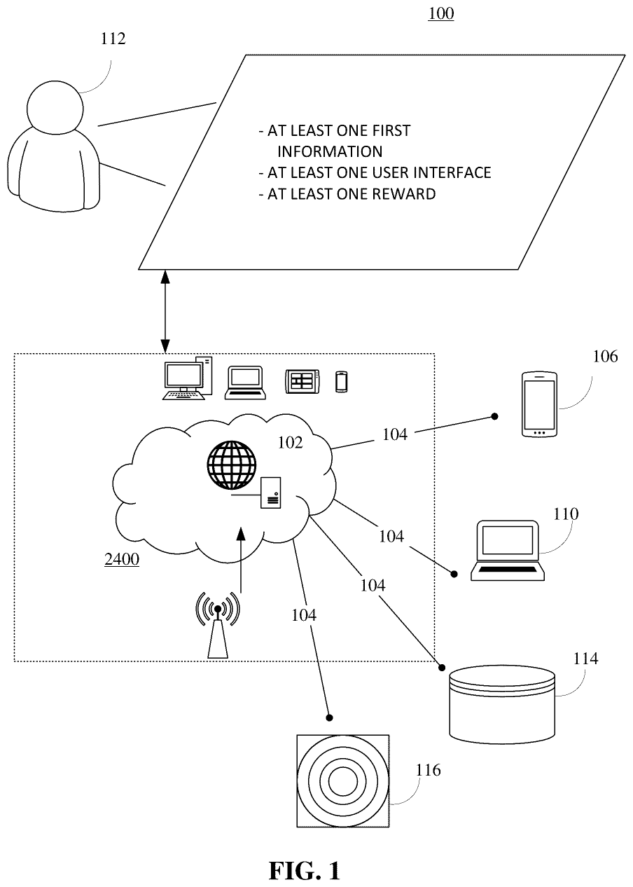

FIG. 1 is an illustration of an online platform 100 consistent with various embodiments of the present disclosure. By way of non-limiting example, the online platform 100 to facilitate provisioning experiences for enhancing engagements may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, users, administrators, service providers, service consumers, participants, customers, players, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 2400.

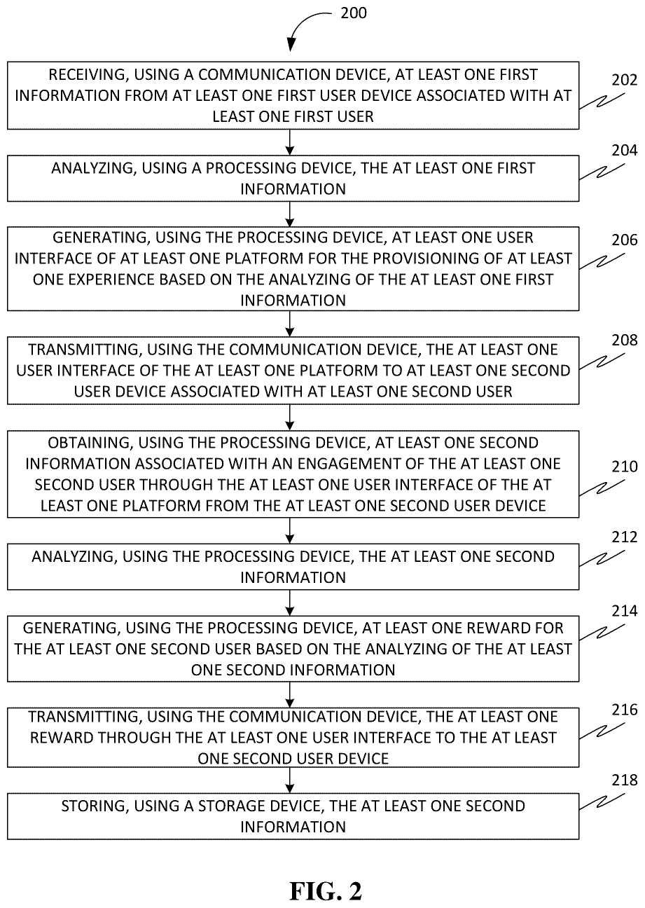

FIG. 2 is a flowchart of a method 200 of provisioning experiences for enhancing engagements, in accordance with some embodiments. Accordingly, at 202, the method 200 may include receiving, using a communication device, at least one first information from at least one first user device associated with at least one first user. Further, the at least one first user may include an entity, a brand, etc. Further, the at least one first user may include an entity representing a brand. Further, the brand may be a company, an organization, an individual, etc. associated with a product, a service, etc. Further, the at least one first information may include an information about the product, the service, etc., of the at least one first user. Further, the information may include a product description, a service description, etc. Further, the at least one first user device may include a user device, a client device, a computing device, an input device, etc. Further, the at least one first information may be a primary information. Further, the at least one first user may be a primary user. Further, the at least one first user device may be a primary user device.

Further, at 204, the method 200 may include analyzing, using a processing device, the at least one first information.

Further, at 206, the method 200 may include generating, using the processing device, at least one user interface of at least one platform for the provisioning of at least one experience based on the analyzing of the at least one first information. Further, the at least one platform may include a web platform, a mobile platform, a personal computer platform, an embedded platform, a gaming platform, a virtual reality platform, an augmented reality platform, an extended reality platform, etc. Further, the at least one experience may include a participatory activity such as a game, a session, a workshop, an event, a conference, a fantasy game, a trading game, a project, a challenge, etc.

Further, at 208, the method 200 may include transmitting, using the communication device, the at least one user interface of the at least one platform to at least one second user device associated with at least one second user.

Further, at 210, the method 200 may include obtaining, using the processing device, at least one second information associated with an engagement of the at least one second user through the at least one user interface of the at least one platform from the at least one second user device. Further, the engagement may include a user engagement. Further, the engagement may include a transaction engagement, an emotional engagement, a behavioral engagement, a cognitive engagement, a social engagement, an experiential engagement, an interactive engagement, a long term relationship engagement, etc. Further, the at least one second user may include a client, a user, a customer, a player, a fan, an individual, etc. Further, the at least one second user device may include a client device, a user device, a computing device, etc. Further, the at least one second information may be obtained in real time. Further, the at least one second information may be a secondary information. Further, the at least one second user may be a secondary user. Further, the at least one second user device may include a secondary user device.

Further, at 212, the method 200 may include analyzing, using the processing device, the at least one second information. Further, the analyzing of the at least one second information may include measuring the engagement of the at least one second user with the at least one first user through the at least one experience.

Further, at 214, the method 200 may include generating, using the processing device, at least one reward for the at least one second user based on the analyzing of the at least one second information. Further, the at least one reward may include at least one token (nonfungible token (NFT)), a prize, a winning, etc.

Further, at 216, the method 200 may include transmitting, using the communication device, the at least one reward through the at least one user interface to the at least one second user device.

Further, at 218, the method 200 may include storing, using a storage device, the at least one second information. Further, the storing of the at least one second information may include storing the at least one second information in at least one distributed ledger of at least one blockchain.

Further, in some embodiments, the at least one second user device may be configured for generating the at least one second information. Further, the obtaining of the at least one second information may be based on the generating of the at least one second information. Further, the method 200 may include determining, using the processing device, an interaction with at least one identifier associated with the at least one experience through the at least one user interface based on the analyzing of the at least one second information. Further, the generating of the at least one reward may be based on the determining of the interaction. Further, the at least one identifier may include a QR code, a Barcode, an alphanumeric code, etc. Further, the at least one identifier may be comprised in at least one physical object. Further, the at least one physical object may include a tag comprising the at least one identifier, a chip (RFID chip, NFC chip, etc.) comprising the at least one identifier. Further, the interaction with the at least one identifier may include scanning, capturing, etc. the at least one identifier. Further, the at least one second user device may include a scanner, a reader, a capturing device, etc.

Further, in some embodiments, the at least one first information may include a marketing value and a marketing cost associated with the engagement. Further, the marketing value may be a value, an amount, etc. the at least one first user expects to derive through the engagements. Further, the marketing cost may be a value, an amount, etc., the at least one first user may be willing to spend. Further, the generating of the at least one user interface of the at least one platform for the provisioning of the at least one experience may include determining an engagement requirement of the at least one first user based on the analyzing of the at least one first information. Further, the engagement requirement may include at least one of a required type and a required level of the engagement required by the at least one first user. Further, the generating of the at least one user interface of the at least one platform for the provisioning of the at least one experience may include selecting at least one option from a plurality of options for engaging the at least one second user with the at least one first user. Further, the plurality of options may include a badge, a point, a thing, and an access. Further, the at least one option characterizes the at least one experience. Further, the generating of the at least one user interface of the at least one platform for the provisioning of the at least one experience may include obtaining at least one activity for the at least one second user using at least one machine learning model by inputting the engagement requirement and the at least one option into the at least one machine learning model. Further, the at least one activity may include visiting a geofenced area, scanning an identifier (QR code), purchasing an item, playing a scavenger hunt, posting a post on a social network, etc. Further, the generating of the at least one user interface of the at least one platform may be based on the obtaining of the at least one activity. Further, the at least one machine learning model may be configured for predicting activities. Further, the at least one machine learning model may be trained based on a plurality of information comprising at least one of a level and a type of the engagement associated with each of a plurality of activities. Further, the at least one user interface may include at least one prompt for prompting the at least one second user for performing the at least one activity. Further, the at least one prompt may include at least one instruction for the at least one second user. Further, the provisioning of the at least one experience may be based on the performing of the at least one activity. Further, the method 200 may include determining, using the processing device, a performance of the at least one activity based on the analyzing of the at least one second user information. Further, the generating of the at least one reward may be based on the determining of the performance. Further, the at least one machine learning model may include a Convolutional Neural Network (CNN) model.

Further, in an embodiment, the CNN model may include a classification model, a semantic segmentation model, etc.

Further, in some embodiments, the method 200 may include obtaining, using the processing device, at least one device information associated with the at least one second device. Further, the at least one device information may include a display size, a resolution, an input device type, a form factor, a hardware configuration, a contextual constraint, etc. Further, the method 200 may include analyzing, using the processing device, the at least one device information. Further, the method 200 may include determining, using the processing device, at least one configuration of the at least one user interface based on the analyzing of the at least one device information. Further, the generating of the at least one user interface may be based on the at least one configuration. Further, the at least one configuration may include a layout, a grid system, a typography, a size of media object, an input control, etc. associated with the at least one user interface.

Further, in an embodiment, the at least one second user device may include at least one location sensor. Further, the at least one location sensor may include a Global Positioning System (GPS) sensor, a position sensor, etc. Further, the at least one location sensor may be configured for generating at least one location information based on detecting a location of the at least one second user device. Further, the at least one second information may include the at least one location information. Further, the obtaining of the at least one second information may be based on the generating of the at least one location information.

Further, in an embodiment, the at least one second user device may include at least one sensor. Further, the at least one sensor may include a camera, a motion sensor, a movement sensor, an eye tracking sensor, etc. Further, the at least one sensor may be configured for generating at least one sensor data based on detecting at least one of a movement, a gesture, and an expression of the at least one second user. Further, the at least one second information may include the at least one sensor data. Further, the obtaining of the at least one second information may be based on the generating of the at least one sensor data.

Further, in some embodiments, the at least one user interface may include at least one map of at least one area. Further, the at least one map may include at least one representation of at least one location on the at least one map. Further, the at least one representation may include an identifier of the at least one user, a number of points, etc. Further, the at least one experience may be associated with the at least one location. Further, the at least one map may include an interactive map. Further, the at least one map may be associated with a scavenger hunt activity for gamifying the engagement. Further, the at least one area may be a real geographical area (city, town, state, etc.), a fictional area, etc.

Further, in an embodiment, the at least one second user device may be configured for generating the at least one second information. Further, the obtaining of the at least one second information may be based on the generating of the at least one second information. Further, the method may include determining, using the processing device, an interaction of the at least one second user with the at least one location through the at least one user interface based on the analyzing of the at least one second information. Further, the generating of the at least one reward may be based on the determining of the interaction. Further, the generation of the at least one reward may include a collection of the number of points associated with the at least one location based on the interaction. Further, the interaction of the at least one second user may include a physical presence of the at least one second user in the at least one location, a purchasing of an item in the at least one location, etc.

Further, in some embodiments, the analyzing of the at least one user second information may include analyzing the at least one second user information using at least one machine learning model. Further, the at least one machine learning model may be configured for classifying at least one user interaction of the at least one user associated with the at least one experience into at least one predefined interaction type. Further, the generating of the at least one reward may be based on the classifying of the at least one user interaction into the at least one predefined interaction type. Further, the at least one machine learning model may include a classifier comprising a sequence to sequence (seq2seq) network architecture and an encoder and a decoder. Further, the at least one predefined interaction type may include a visiting of a geofenced area, posting a post on a social network, purchasing an item, etc.

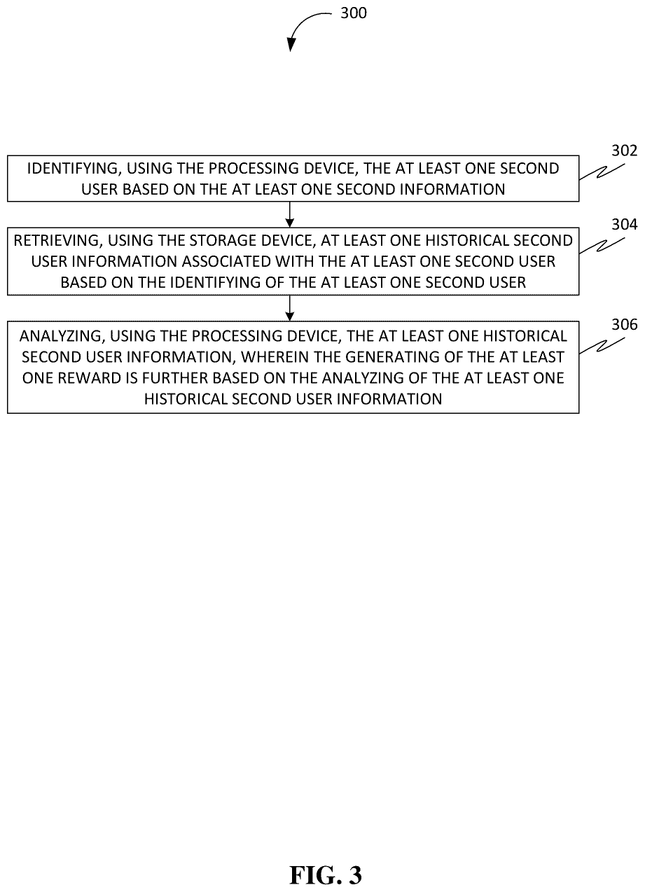

FIG. 3 is a flowchart of a method 300 of provisioning experiences for enhancing engagements, in accordance with some embodiments. Accordingly, at 302, the method 300 may include identifying, using the processing device, the at least one second user based on the at least one second information.

Further, at 304, the method 300 may include retrieving, using the storage device, at least one historical second user information associated with the at least one second user based on the identifying of the at least one second user.

Further, at 306, the method 300 analyzing, using the processing device, the at least one historical second user information. Further, the generating of the at least one reward may be based on the analyzing of the at least one historical second user information.

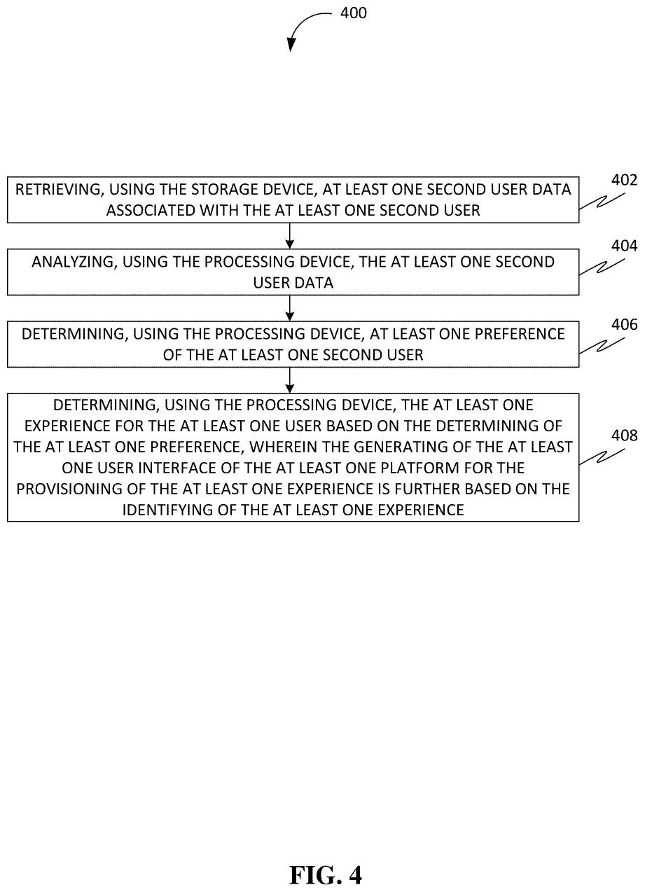

FIG. 4 is a flowchart of a method 400 of provisioning experiences for enhancing engagements, in accordance with some embodiments. Accordingly, at 402, the method 400 may include retrieving, using the storage device, at least one second user data associated with the at least one second user. Further, the at least one user data may include a social media data associated with a social media activity of the at least one second user, a personal information (age, sex, gender, origin, ethnicity, residence, etc.) of the at least one second user, etc.

Further, at 404, the method 400 may include analyzing, using the processing device, the at least one second user data.

Further, at 406, the method 400 may include determining, using the processing device, at least one preference of the at least one second user. Further, the at least one preference may include a preferred location, a preferred item, a preferred activity, a preferred color, a preferred personality, etc.

Further, at 408, the method 400 may include determining, using the processing device, the at least one experience for the at least one user based on the determining of the at least one preference. Further, the generating of the at least one user interface of the at least one platform for the provisioning of the at least one experience may be based on the identifying of the at least one experience.

Further, in some embodiments, the obtaining of the at least one activity for the at least one second user using the at least one machine learning model by the inputting of the engagement requirement and the at least one option into the at least one machine learning model may include obtaining the at least one activity for the at least one second user using the at least one machine learning model by the inputting the at least one preference, the engagement requirement, and the at least one option into the at least one machine learning model based on the determining of the at least one preference. Further, the determining of the at least one experience may be based on the obtaining of the at least one activity for the at least one second user using the at least one machine learning model by the inputting of the at least one preference, the engagement requirement, and the at least one option into the at least one machine learning model.

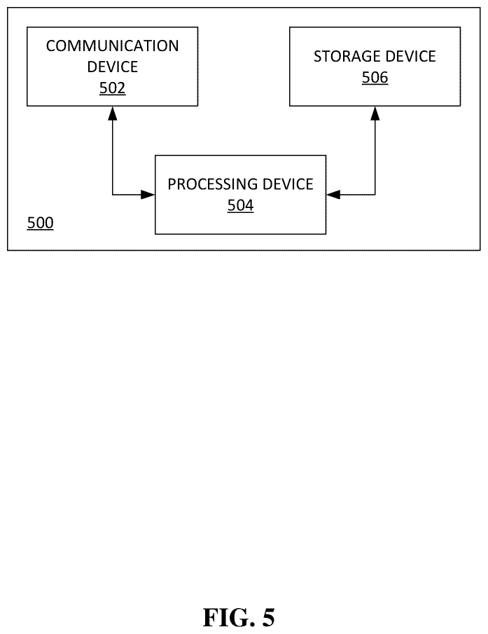

FIG. 5 is a block diagram of a system 500 for provisioning experiences for enhancing engagements, in accordance with some embodiments. Accordingly, the system 500 may include a communication device 502, a processing device 504, and a storage device 506.

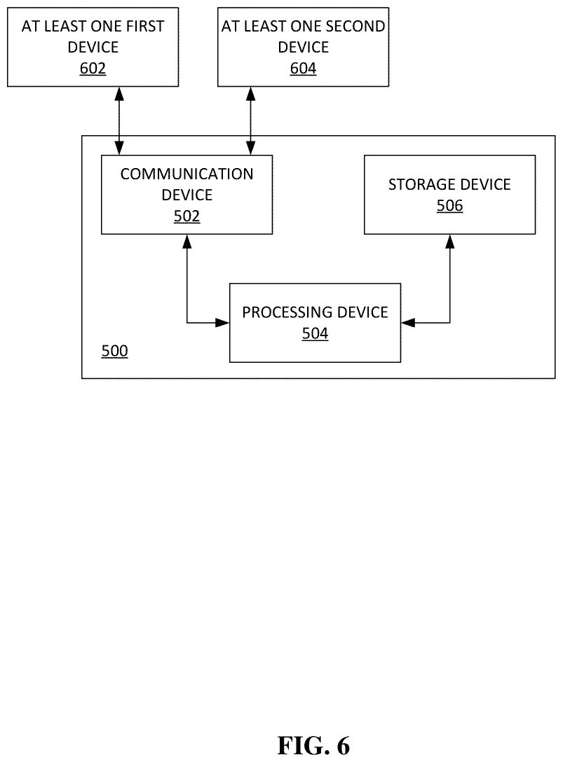

Further, the communication device 502 may be configured for receiving at least one first information from at least one first user device 602, as shown in FIG. 6, associated with at least one first user. Further, the communication device 502 may be configured for transmitting at least one user interface of at least one platform to at least one second user device 604, as shown in FIG. 6, associated with at least one second user. Further, the communication device 502 may be configured for transmitting at least one reward through the at least one user interface to the at least one second user device 604.

Further, the processing device 504 may be communicatively coupled with the communication device 502. Further, the processing device 504 may be configured for analyzing the at least one first information. Further, the processing device 504 may be configured for generating the at least one user interface of the at least one platform for the provisioning of at least one experience based on the analyzing of the at least one first information. Further, the processing device 504 may be configured for obtaining at least one second information associated with an engagement of the at least one second user through the at least one user interface of the at least one platform from the at least one second user device 604. Further, the processing device 504 may be configured for analyzing the at least one second information. Further, the processing device 504 may be configured for generating the at least one reward for the at least one second user based on the analyzing of the at least one second information.

Further, the storage device 506 may be communicatively coupled with the processing device 504. Further, the storage device 506 may be configured for storing the at least one second information.

Further, in some embodiments, the at least one second user device 604 may be configured for generating the at least one second information. Further, the obtaining of the at least one second information may be based on the generating of the at least one second information. Further, the processing device 504 may be configured for determining an interaction with at least one identifier associated with the at least one experience through the at least one user interface based on the analyzing of the at least one second information. Further, the generating of the at least one reward may be based on the determining of the interaction.

Further, in some embodiments, the processing device 504 may be configured for identifying the at least one second user based on the at least one second information. Further, the processing device 504 may be configured for analyzing at least one historical second user information. Further, the generating of the at least one reward may be based on the analyzing of the at least one historical second user information. Further, the storage device 506 may be configured for retrieving the at least one historical second user information associated with the at least one second user based on the identifying of the at least one second user.

Further, in some embodiments, the at least one first information may include a marketing value and a marketing cost associated with the engagement. Further, the marketing value may be a value, an amount, etc. the at least one first user expects to derive through the engagements. Further, the marketing cost may be a value, an amount, etc., the at least one first user may be willing to spend. Further, the generating of the at least one user interface of the at least one platform for the provisioning of the at least one experience may include determining an engagement requirement of the at least one first user based on the analyzing of the at least one first information. Further, the generating of the at least one user interface of the at least one platform for the provisioning of the at least one experience may include selecting at least one option from a plurality of options for engaging the at least one second user with the at least one first user. Further, the at least one option characterizes the at least one experience. Further, the generating of the at least one user interface of the at least one platform for the provisioning of the at least one experience may include obtaining at least one activity for the at least one second user using at least one machine learning model by inputting the engagement requirement and the at least one option into the at least one machine learning model. Further, the generating of the at least one user interface of the at least one platform may be based on the obtaining of the at least one activity. Further, the at least one machine learning model may be configured for predicting activities. Further, the at least one machine learning model may be trained based on a plurality of information comprising at least one of a level and a type of the engagement associated with each of a plurality of activities. Further, the at least one user interface may include at least one prompt for prompting the at least one second user for performing the at least one activity. Further, the provisioning of the at least one experience may be based on the performing of the at least one activity. Further, the processing device 504 may be configured for determining a performance of the at least one activity based on the analyzing of the at least one second user information. Further, the generating of the at least one reward may be based on the determining of the performance.

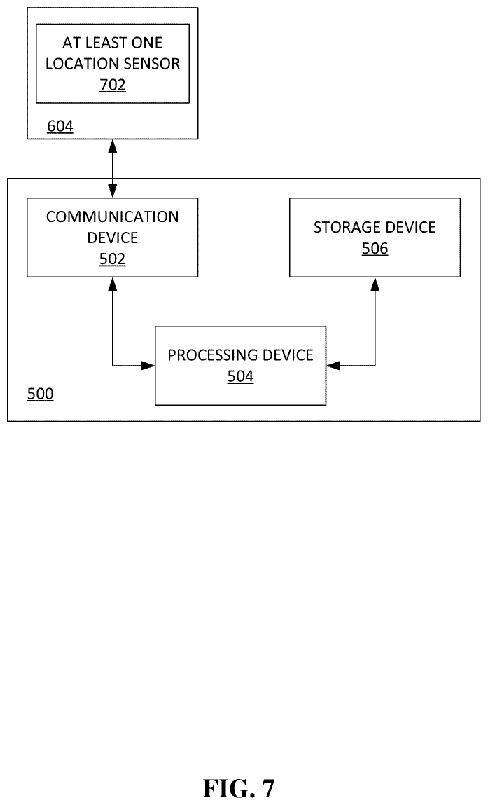

Further, in an embodiment, the at least one second user device 604 may include at least one location sensor 702, as shown in FIG. 7. Further, the at least one location sensor 702 may be configured for generating at least one location information based on detecting a location of the at least one second user device 604. Further, the at least one second information may include the at least one location information.

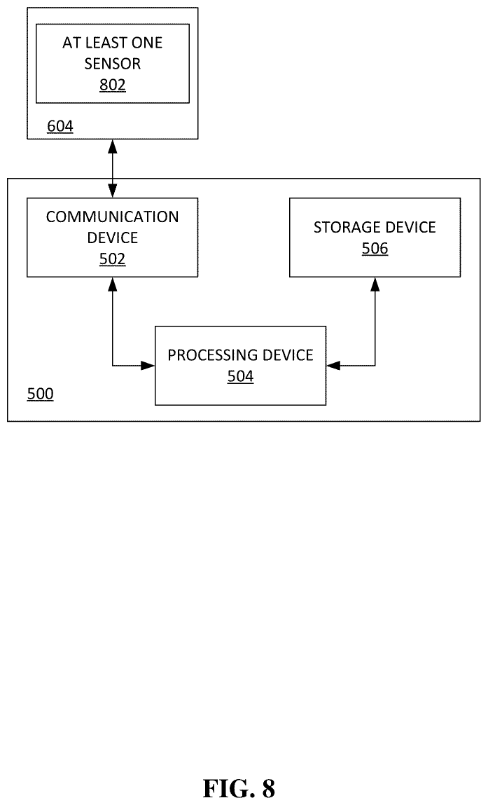

Further, in an embodiment, the at least one second user device 604 may include at least one sensor 802, as shown in FIG. 8. Further, the at least one sensor 802 may be configured for generating at least one sensor data based on detecting at least one of a movement, a gesture, and an expression of the at least one second user. Further, the at least one second information may include the at least one sensor data.

Further, in some embodiments, the at least one user interface may include at least one map of at least one area. Further, the at least one map may include at least one representation of at least one location on the at least one map. Further, the at least one experience may be associated with the at least one location.

Further, in an embodiment, the at least one second user device 604 may be configured for generating the at least one second information. Further, the obtaining of the at least one second information may be based on the generating of the at least one second information. Further, the processing device 504 may be configured for determining an interaction of the at least one second user with the at least one location through the at least one user interface based on the analyzing of the at least one second information. Further, the generating of the at least one reward may be based on the determining of the interaction

Further, in some embodiments, the storage device 506 may be configured for retrieving at least one second user data associated with the at least one second user. Further, the processing device 504 may be configured for analyzing the at least one second user data. Further, the processing device 504 may be configured for determining at least one preference of the at least one second user. Further, the processing device 504 may be configured for determining the at least one experience for the at least one user based on the determining of the at least one preference. Further, the generating of the at least one user interface of the at least one platform for organizing the at least one experience may be based on the identifying of the at least one experience.

Further, in some embodiments, the analyzing of the at least one user second information may include analyzing the at least one second user information using at least one machine learning model. Further, the at least one machine learning model may be configured for classifying at least one user interaction of the at least one user associated with the at least one experience into at least one predefined interaction type. Further, the generating of the at least one reward may be further based on the classifying of the at least one user interaction into the at least one predefined interaction type.

FIG. 6 is a block diagram of the system 500, in accordance with some embodiments.

FIG. 7 is a block diagram of the system 500, in accordance with some embodiments.

FIG. 8 is a block diagram of the system 500, in accordance with some embodiments.

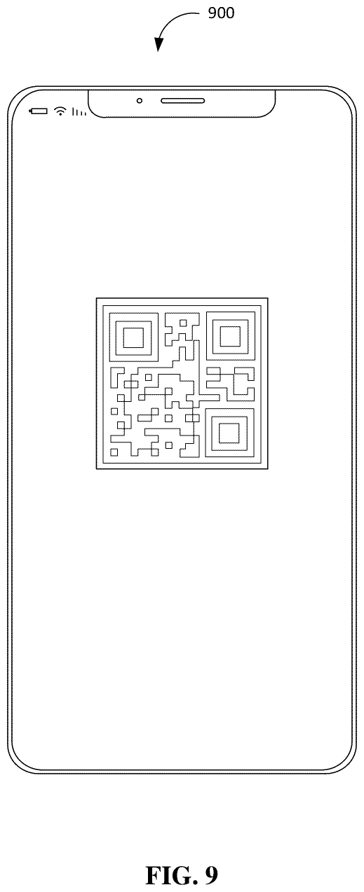

FIG. 9 is a screenshot of a user interface 900 of an application for scanning a QR code for provisioning experiences for enhancing engagements, in accordance with some embodiments.

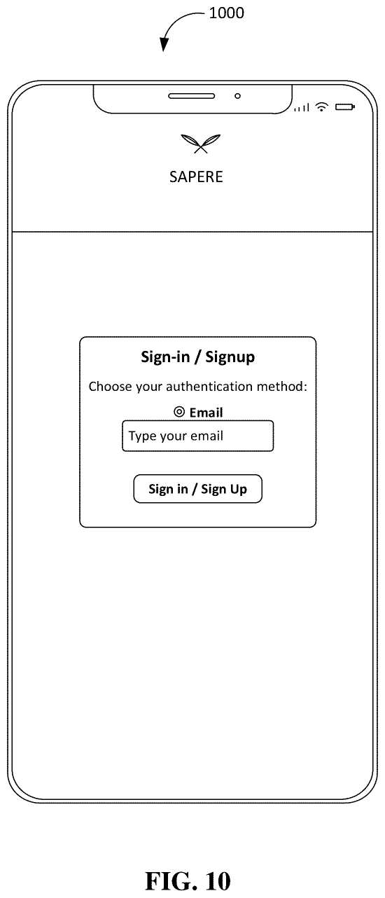

FIG. 10 is a screenshot of a user interface 1000 of the application for signing up, in accordance with some embodiments.

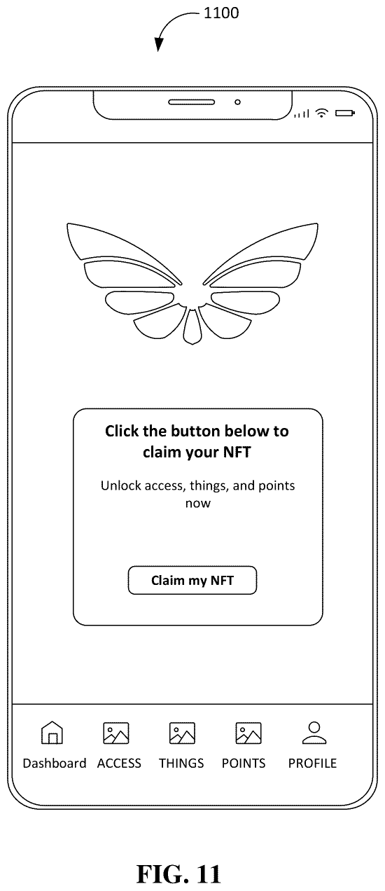

FIG. 11 is a screenshot of a user interface 1100 of the application for claiming collectibles to earn points in an experience, in accordance with some embodiments.

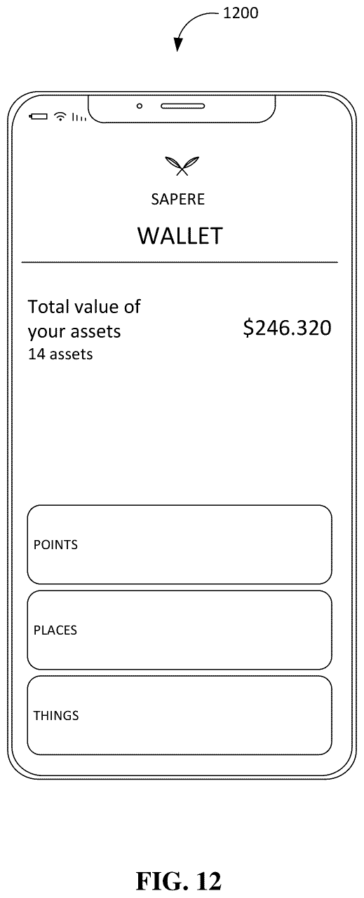

FIG. 12 is a screenshot of a user interface 1200 of the application for keeping track of points and activities, in accordance with some embodiments.

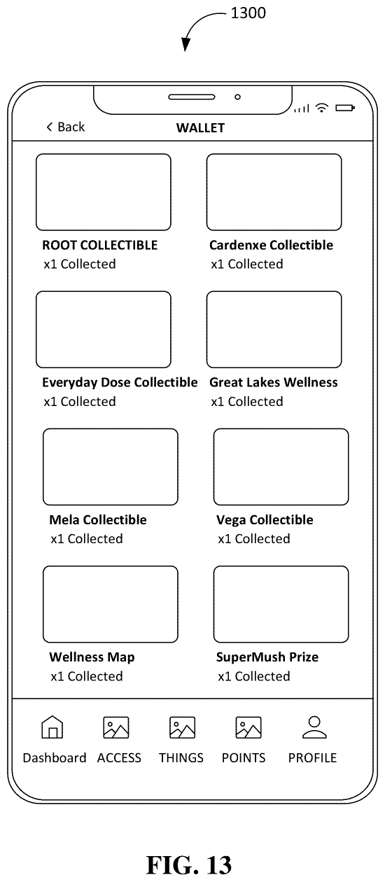

FIG. 13 is a screenshot of a user interface 1300 of the application for displaying a history of attendances and interaction of a user, in accordance with some embodiments.

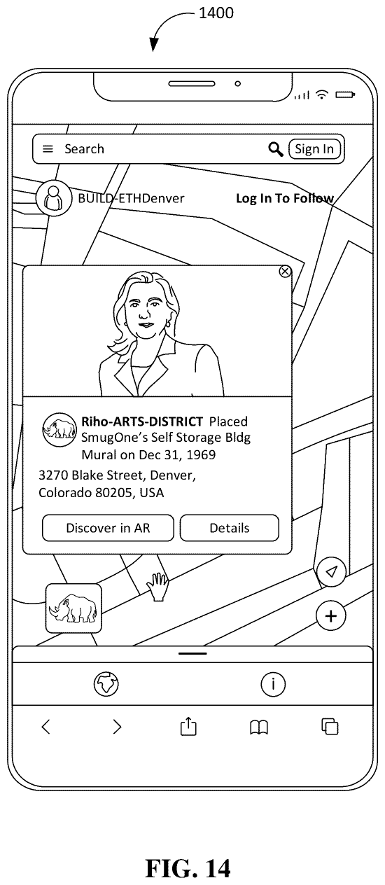

FIG. 14 is a screenshot of a user interface 1400 of an interactive map of the application, in accordance with some embodiments.

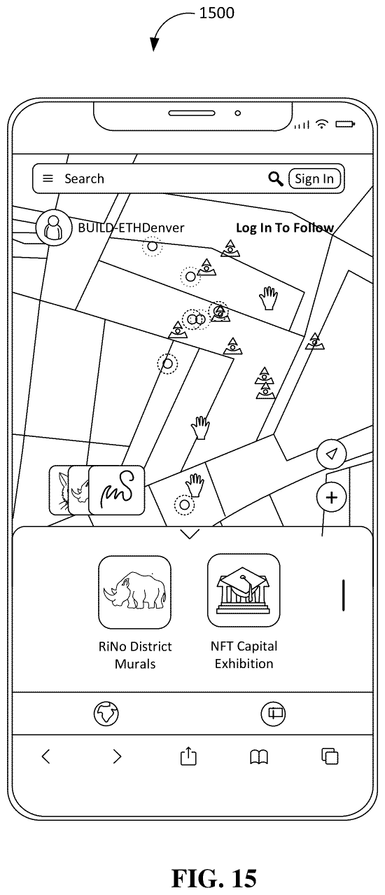

FIG. 15 is a screenshot of a user interface 1500 of the interactive map of the application, in accordance with some embodiments.

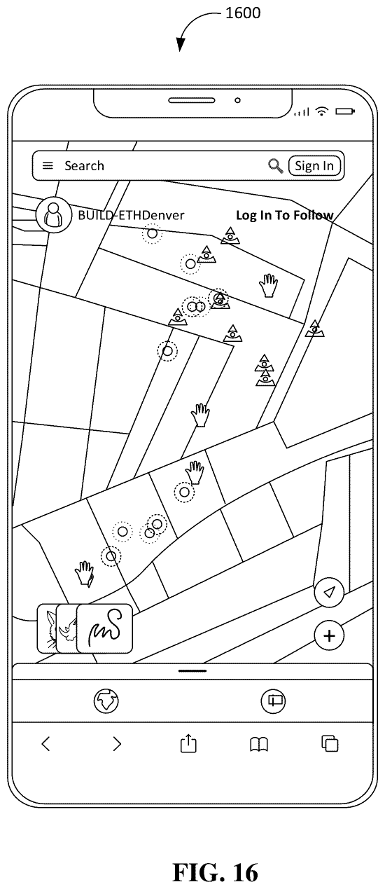

FIG. 16 is a screenshot of a user interface 1600 of the interactive map of the application, in accordance with some embodiments.

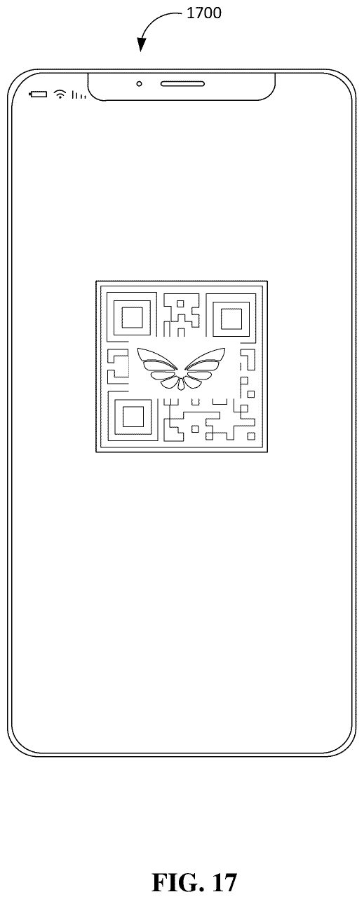

FIG. 17 is a screenshot of a user interface 1700 of an application for scanning a QR code for provisioning experiences for enhancing engagements, in accordance with some embodiments.

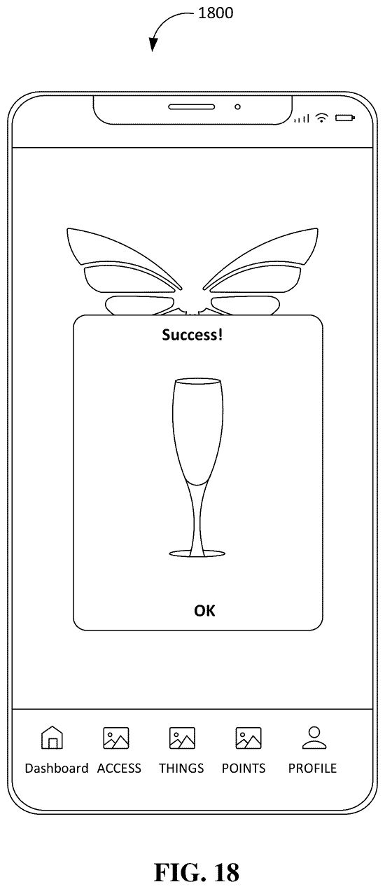

FIG. 18 is a screenshot of a user interface 1800 of the application for claiming a collectible, in accordance with some embodiments.

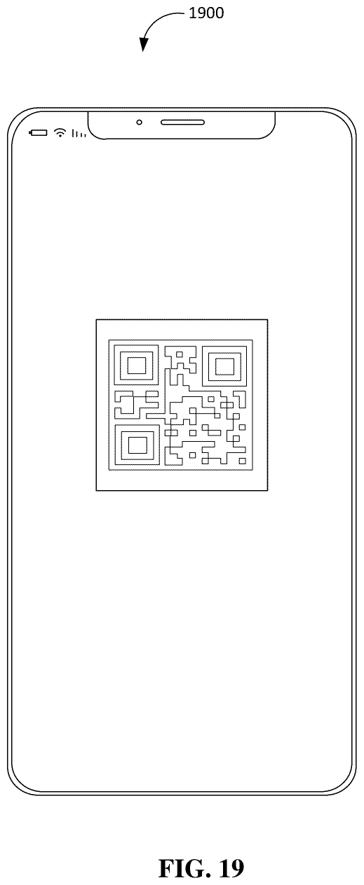

FIG. 19 is a screenshot of a user interface 1900 of an application for scanning a QR code for provisioning experiences for enhancing engagements, in accordance with some embodiments.

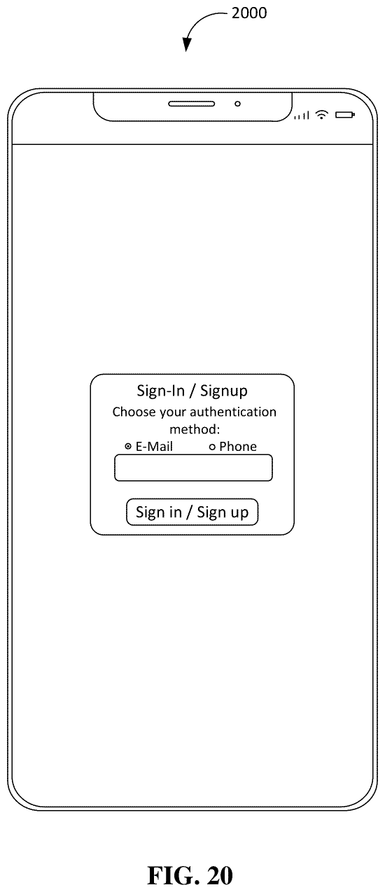

FIG. 20 is a screenshot of a user interface 2000 of the application for signing up, in accordance with some embodiments.

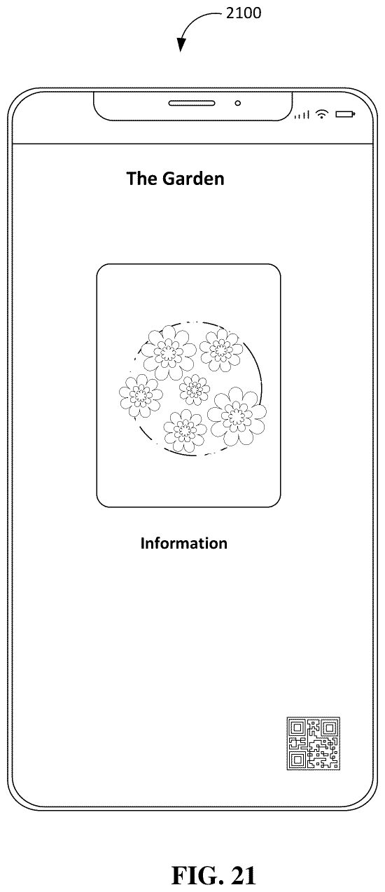

FIG. 21 is a screenshot of a user interface 2100 of the application for recording activities, in accordance with some embodiments.

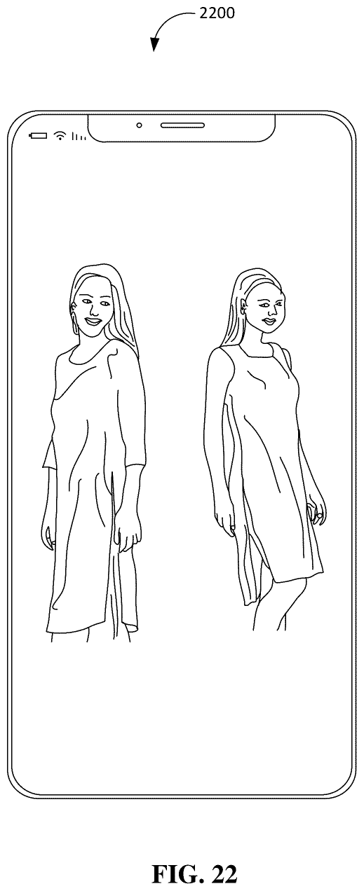

FIG. 22 is a screenshot of a user interface 2200 of an application for scanning a tag comprised in a garment for provisioning experiences for enhancing engagements, in accordance with some embodiments.

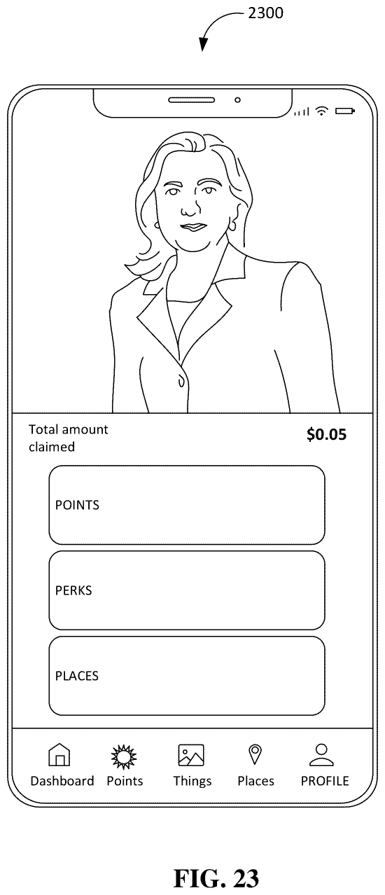

FIG. 23 is a screenshot of a user interface 2300 of the application for keeping track of points, perks, and places, in accordance with some embodiments.

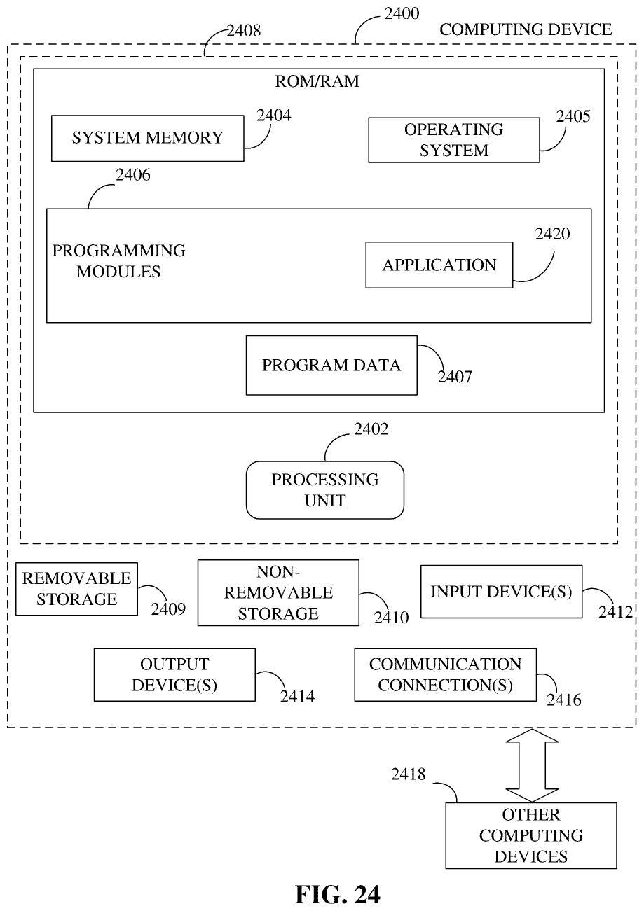

With reference to FIG. 24, a system consistent with an embodiment of the disclosure may include a computing device or cloud service, such as computing device 2400. In a basic configuration, computing device 2400 may include at least one processing unit 2402 and a system memory 2404. Depending on the configuration and type of computing device, system memory 2404 may comprise, but is not limited to, volatile (e.g. random-access memory (RAM)), non-volatile (e.g. read-only memory (ROM)), flash memory, or any combination. System memory 2404 may include operating system 2405, one or more programming modules 2406, and may include a program data 2407. Operating system 2405, for example, may be suitable for controlling computing device 2400's operation. In one embodiment, programming modules 2406 may include image-processing module, machine learning module. Furthermore, embodiments of the disclosure may be practiced in conjunction with a graphics library, other operating systems, or any other application program and is not limited to any particular application or system. This basic configuration is illustrated in FIG. 24 by those components within a dashed line 2408.

Computing device 2400 may have additional features or functionality. For example, computing device 2400 may also include additional data storage devices (removable and/or non-removable) such as, for example, magnetic disks, optical disks, or tape. Such additional storage is illustrated in FIG. 24 by a removable storage 2409 and a non-removable storage 2410. Computer storage media may include volatile and non-volatile, removable and non-removable media implemented in any method or technology for storage of information, such as computer-readable instructions, data structures, program modules, or other data. System memory 2404, removable storage 2409, and non-removable storage 2410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2400. Any such computer storage media may be part of device 2400. Computing device 2400 may also have input device(s) 2412 such as a keyboard, a mouse, a pen, a sound input device, a touch input device, a location sensor, a camera, a biometric sensor, etc. Output device(s) 2414 such as a display, speakers, a printer, etc. may also be included. The aforementioned devices are examples and others may be used.

Computing device 2400 may also contain a communication connection 2416 that may allow device 2400 to communicate with other computing devices 2418, such as over a network in a distributed computing environment, for example, an intranet or the Internet. Communication connection 2416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2404, including operating system 2405. While executing on processing unit 2402, programming modules 2406 (e.g., application 2420 such as a media player) may perform processes including, for example, one or more stages of methods, algorithms, systems, applications, servers, databases as described above. The aforementioned process is an example, and processing unit 2402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of provisioning experiences for enhancing engagements, the method comprising:
receiving, using a communication device, at least one first information from at least one first user device associated with at least one first user;
analyzing, using a processing device, the at least one first information;
generating, using the processing device, at least one user interface of at least one platform for the provisioning of at least one experience based on the analyzing of the at least one first information;
transmitting, using the communication device, the at least one user interface of the at least one platform to at least one second user device associated with at least one second user;
obtaining, using the processing device, at least one second information associated with an engagement of the at least one second user through the at least one user interface of the at least one platform from the at least one second user device;
analyzing, using the processing device, the at least one second information;
generating, using the processing device, at least one reward for the at least one second user based on the analyzing of the at least one second information; and
transmitting, using the communication device, the at least one reward through the at least one user interface to the at least one second user device; and
storing, using a storage device, the at least one second information.

2. The method of claim 1, wherein the at least one second user device is configured for generating the at least one second information, wherein the obtaining of the at least one second information is based on the generating of the at least one second information, wherein the method further comprises determining, using the processing device, an interaction with at least one identifier associated with the at least one experience through the at least one user interface based on the analyzing of the at least one second information, wherein the generating of the at least one reward is further based on the determining of the interaction.

3. The method of claim 1 further comprising:
identifying, using the processing device, the at least one second user based on the at least one second information;
retrieving, using the storage device, at least one historical second user information associated with the at least one second user based on the identifying of the at least one second user; and
analyzing, using the processing device, the at least one historical second user information, wherein the generating of the at least one reward is further based on the analyzing of the at least one historical second user information.

4. The method of claim 1, wherein the at least one first information comprises a marketing value and a marketing cost associated with the engagement, wherein the generating of the at least one user interface of the at least one platform for the provisioning of the at least one experience comprises:
determining an engagement requirement of the at least one first user based on the analyzing of the at least one first information;
selecting at least one option from a plurality of options for engaging the at least one second user with the at least one first user, wherein the at least one option characterizes the at least one experience; and
obtaining at least one activity for the at least one second user using at least one machine learning model by inputting the engagement requirement and the at least one option into the at least one machine learning model, wherein the generating of the at least one user interface of the at least one platform is further based on the obtaining of the at least one activity, wherein the at least one machine learning model is configured for predicting activities, wherein the at least one machine learning model is trained based on a plurality of information comprising at least one of a level and a type of the engagement associated with each of a plurality of activities, wherein the at least one user interface comprises at least one prompt for prompting the at least one second user for performing the at least one activity, wherein the provisioning of the at least one experience is based on the performing of the at least one activity, wherein the method further comprises determining, using the processing device, a performance of the at least one activity based on the analyzing of the at least one second user information, wherein the generating of the at least one reward is further based on the determining of the performance.

5. The method of claim 4, wherein the at least one second user device comprises at least one location sensor, wherein the at least one location sensor is configured for generating at least one location information based on detecting a location of the at least one second user device, wherein the at least one second information comprises the at least one location information.

6. The method of claim 4, wherein the at least one second user device comprises at least one sensor, wherein the at least one sensor is configured for generating at least one sensor data based on detecting at least one of a movement, a gesture, and an expression of the at least one second user, wherein the at least one second information comprises the at least one sensor data.

7. The method of claim 1, wherein the at least one user interface comprises at least one map of at least one area, wherein the at least one map comprises at least one representation of at least one location on the at least one map, wherein the at least one experience is associated with the at least one location.

8. The method of claim 7, wherein the at least one second user device is configured for generating the at least one second information, wherein the obtaining of the at least one second information is based on the generating of the at least one second information, wherein the method further comprises determining, using the processing device, an interaction of the at least one second user with the at least one location through the at least one user interface based on the analyzing of the at least one second information, wherein the generating of the at least one reward is further based on the determining of the interaction.

9. The method of claim 1 further comprising:
retrieving, using the storage device, at least one second user data associated with the at least one second user;
analyzing, using the processing device, the at least one second user data;
determining, using the processing device, at least one preference of the at least one second user; and
determining, using the processing device, the at least one experience for the at least one user based on the determining of the at least one preference, wherein the generating of the at least one user interface of the at least one platform for the provisioning of the at least one experience is further based on the identifying of the at least one experience.

10. The method of claim 1, wherein the analyzing of the at least one user second information comprises analyzing the at least one second user information using at least one machine learning model, wherein the at least one machine learning model is configured for classifying at least one user interaction of the at least one user associated with the at least one experience into at least one predefined interaction type, wherein the generating of the at least one reward is further based on the classifying of the at least one user interaction into the at least one predefined interaction type.

11. A system for provisioning experiences for enhancing engagements, the system comprising:
a communication device configured for:
receiving at least one first information from at least one first user device associated with at least one first user;
transmitting at least one user interface of at least one platform to at least one second user device associated with at least one second user; and
transmitting at least one reward through the at least one user interface to the at least one second user device;
a processing device communicatively coupled with the communication device, wherein the processing device is configured for:
analyzing the at least one first information;
generating the at least one user interface of the at least one platform for the provisioning of at least one experience based on the analyzing of the at least one first information;
obtaining at least one second information associated with an engagement of the at least one second user through the at least one user interface of the at least one platform from the at least one second user device;
analyzing the at least one second information; and
generating the at least one reward for the at least one second user based on the analyzing of the at least one second information; and
a storage device communicatively coupled with the processing device, wherein the storage device is configured for storing the at least one second information.

12. The system of claim 11, wherein the at least one second user device is configured for generating the at least one second information, wherein the obtaining of the at least one second information is based on the generating of the at least one second information, wherein the processing device is further configured for determining an interaction with at least one identifier associated with the at least one experience through the at least one user interface based on the analyzing of the at least one second information, wherein the generating of the at least one reward is further based on the determining of the interaction.

13. The system of claim 11, wherein the processing device is further configured for:
identifying the at least one second user based on the at least one second information; and
analyzing at least one historical second user information, wherein the generating of the at least one reward is further based on the analyzing of the at least one historical second user information, wherein the storage device is further configured for retrieving the at least one historical second user information associated with the at least one second user based on the identifying of the at least one second user.

14. The system of claim 11, wherein the at least one first information comprises a marketing value and a marketing cost associated with the engagement, wherein the generating of the at least one user interface of the at least one platform for the provisioning of the at least one experience comprises:
determining an engagement requirement of the at least one first user based on the analyzing of the at least one first information;
selecting at least one option from a plurality of options for engaging the at least one second user with the at least one first user, wherein the at least one option characterizes the at least one experience; and
obtaining at least one activity for the at least one second user using at least one machine learning model by inputting the engagement requirement and the at least one option into the at least one machine learning model, wherein the generating of the at least one user interface of the at least one platform is further based on the obtaining of the at least one activity, wherein the at least one machine learning model is configured for predicting activities, wherein the at least one machine learning model is trained based on a plurality of information comprising at least one of a level and a type of the engagement associated with each of a plurality of activities, wherein the at least one user interface comprises at least one prompt for prompting the at least one second user for performing the at least one activity, wherein the provisioning of the at least one experience is based on the performing of the at least one activity, wherein the processing device is further configured for determining a performance of the at least one activity based on the analyzing of the at least one second user information, wherein the generating of the at least one reward is further based on the determining of the performance.

15. The system of claim 14, wherein the at least one second user device comprises at least one location sensor, wherein the at least one location sensor is configured for generating at least one location information based on detecting a location of the at least one second user device, wherein the at least one second information comprises the at least one location information.

16. The system of claim 14, wherein the at least one second user device comprises at least one sensor, wherein the at least one sensor is configured for generating at least one sensor data based on detecting at least one of a movement, a gesture, and an expression of the at least one second user, wherein the at least one second information comprises the at least one sensor data.

17. The system of claim 11, wherein the at least one user interface comprises at least one map of at least one area, wherein the at least one map comprises at least one representation of at least one location on the at least one map, wherein the at least one experience is associated with the at least one location.

18. The system of claim 17, wherein the at least one second user device is configured for generating the at least one second information, wherein the obtaining of the at least one second information is based on the generating of the at least one second information, wherein the processing device is further configured for determining an interaction of the at least one second user with the at least one location through the at least one user interface based on the analyzing of the at least one second information, wherein the generating of the at least one reward is further based on the determining of the interaction.

19. The system of claim 11, wherein the storage device is further configured for retrieving at least one second user data associated with the at least one second user, wherein the processing device is further configured for:
analyzing the at least one second user data;
determining at least one preference of the at least one second user; and
determining the at least one experience for the at least one user based on the determining of the at least one preference, wherein the generating of the at least one user interface of the at least one platform for the provisioning of the at least one experience is further based on the identifying of the at least one experience.

20. The system of claim 11, wherein the analyzing of the at least one user second information comprises analyzing the at least one second user information using at least one machine learning model, wherein the at least one machine learning model is configured for classifying at least one user interaction of the at least one user associated with the at least one experience into at least one predefined interaction type, wherein the generating of the at least one reward is further based on the classifying of the at least one user interaction into the at least one predefined interaction type.
